(19) United States
(12) Patent Application Publication
(10) Pub. No.: US 2024/0281884 A1
(43) Pub. Date: Aug. 22, 2024

(54) METHOD FOR RECOMMENDING FINANCIAL PRODUCT SALES STRATEGY BASED ON DETECTION OF FINANCIAL PRODUCTS IN SIMILAR TREND

(71) Applicant: MONEYSTATION INC., Seoul (KR)

(72) Inventor: Jungil LEE, Seoul (KR)

(73) Assignee: MONEYSTATION INC., Seoul (KR)

(21) Appl. No.: 18/113,782

(22) Filed: Feb. 24, 2023

(30) Foreign Application Priority Data
Feb. 16, 2023 (KR) 10-2023-0020683

(51) Int. Cl. G06Q 40/06

(52) U.S. Cl. CPC G06Q 40/06

(57) ABSTRACT

A method for recommending financial product sales strategy includes inquiring price information of a plurality of financial products according to elapsed time; extracting at least one financial product pair or more determined to have a same price trend or a price trend equal to or less than a predetermined difference on specific period information from among the plurality of financial products; determining a periodicity of a spread graph for a price difference or price ratio of two financial products in the extracted financial product pair, and selecting a recommended financial product pair based on at least one of the average, standard deviation, trend line by regression analysis, and standard error of the spread graph; and recommending at least one of borrowed selling, short selling, future selling contract, and net selling only limited to the user terminal that already owns the financial product for an overvalued financial product.

### CROSS-REFERENCE TO RELATED APPLICATION

This application is based on and claims priority under 35 U.S.C. § 119 to Korean Patent Application No. 10-2023-0020683, filed on Feb. 16, 2023, in the Korean Intellectual Property Office, the disclosure of which is incorporated by reference herein in its entirety.

### BACKGROUND

### 1. Field

The present disclosure relates to a method for recommending financial product sales strategy based on detection of financial products in similar trend, and more particularly relates to a method for removing a risk of entire financial market in an investment portfolio through arbitrage trading for corresponding financial products by organizing, as a pair, two financial products showing the same or similar trends in financial product trading.

### 2. Description of the Related Art

In the conventional financial product trading market, especially in the stock trading market, since it is difficult to predict the direction and volatility, preparation for an investment method that pursue profits regardless of market conditions is insufficient.

Due to the birth of new financial products such as derivatives, ETF, and ETN, and the development of new financial institutions such as loan sale and short sale, various and complex investment methods have emerged that may pursue profits even when the value of financial assets declines. However, it is still difficult for individual investors to enter the hedge fund/institutional investment.

Recently, various financial product investments have become popular with the public, and individual investors are jumping into the financial product trading market. According to one statistic, in the first quarter of 2021, domestic security companies in Korea generated the largest net profit ever, which is believed to have been influenced by the investment craze by individual investors.

Therefore, there is a need for a technology for intuitively and easily conveying the know-how of existing financial workers to these individual investors.

### SUMMARY

The present disclosure is provided to solve the problems of the prior art described above, and an object of the present disclosure is to provide users with search for arbitrage trading opportunities in the financial product trading market, for example, the stock trading market, where direction and volatility are difficult to predict, and recommend trading products.

Furthermore, in the field of institutional investment, which is irrelevant to market conditions and in which analysis of expected profit and loss is very difficult, the present disclosure proposes a method for providing individual investors with investment time and investment items that may safely pursue profits with low risk.

The problems to be solved by the present disclosure are not limited to the problems mentioned above, and other problems not mentioned will be clearly understood from the description below.

As technical means for achieving technical problems described above, according to an example of the present disclosure, there is provided a method for recommending financial product sales strategy based on detection of financial products in similar trend, the method including: (a) inquiring price information of a plurality of financial products according to elapsed time; (b) extracting at least one financial product pair or more determined to have a same price trend or a price trend equal to or less than a predetermined difference on specific period information from among the plurality of financial products; (c) determining a periodicity of a spread graph for a price difference or price ratio of two financial products in the extracted financial product pair, and selecting a recommended financial product pair based on at least one of the average, standard deviation, trend line by regression analysis, and standard error of the spread graph; and (d) recommending at least one of borrowed selling, short selling, future selling contract, and net selling only limited to the user terminal that already owns the financial product for an overvalued financial product, recommending buying for an undervalued financial product among two recommended financial product pairs when a current value on the spread graph for the recommended financial product pair is equal to or greater than a predetermined standard deviation or a multiple of the standard error, and providing the user terminal with profit rate information about an expected profit rate for a predetermined period after the time point of selling or buying.

In addition, the spread graph may be a graph in which an amount of a change in a value divided between prices of two financial products or a difference value therebetween is expressed as a line for a predetermined period.

In addition, the profit rate information may predict a point at which the spread graph is expected to regress to an average value from the current time point, and may be calculated based on a ratio of a numerical value of the spread graph between the time point and the current time point.

In addition, in step (a), the user terminal may be provided with a financial product recommendation UI including at least one of a period information input function, a desired profit rate input function, a price information graph display function, a minimum expected profit rate setting UI, and a detailed information UI, and the period information may be received from the user terminal.

In addition, the financial product recommendation UI may further include a volatility adjustment UI that receives a volatility value from the user terminal and adjusts a range of the volatility between items for searching for a financial product pair whose volatility ratio for price changes of two items is within a certain input range.

In addition, the financial product recommendation UI may further include a standard deviation and standard deviation setting UI that receives, from the user terminal, an input signal for inputting a parameter for setting a multiple of the standard deviation or standard error on the spread graph at the time of buying and selling between two financial products, calculates the average value, standard deviation, linear regression estimation value, and standard error of the spread graph between specific two financial products, and provides a financial product pair for which the current value of the spread graph corresponds to a predetermined multiple of the standard deviation or the standard error according to the input signal.

In addition, step (b) may include dividing, into a plurality of predetermined intervals, the period information for specific period information among the plurality of financial products, and determining to have a similar trend when price information rises or falls together at the interval, or a slope of a trend line of each financial product derived by regression analysis is within a predetermined difference.

In addition, in step (b), two financial products with high price similarity of a plurality of financial products may be searched, and step (b) may include (b-1) searching for two financial products whose price volatility difference or ratio between the two financial products for a specific period information is equal to or greater than, or less than a predetermined numerical range among a plurality of financial products, and extracting the two financial products as a financial product pair.

In addition, in step (b), two financial products, whose desired profit rate corresponds to the expected profit value when the expected profit value is equal to or greater than the desired profit rate input in the user terminal by being compared, based on the expected profit value when liquidating a position estimated from a distance between a current value of the spread graph between two financial products, and each average value of a measurement period of the spread graph between the two financial products, when the desired profit rate received from the user terminal is equal to or greater than a predetermined value among the plurality of financial products, may be extracted as the financial product pair.

In addition, in step (c), an average and standard deviation method may be applied when the spread graph has no slope or has a slope equal to or less than a predetermined value, and a regression analysis and standard error method may be applied when the slope of the spread graph is equal to or greater than, or less than the predetermined value.

In addition, in step (d), an average and a standard deviation of a price of each financial product may be calculated for the two financial products of the recommended financial product pair, a financial product, of which the normalized price obtained by normalizing a current value of each financial product is higher in the two financial product, may be determined as being overvalued, and the rest thereof may be determined as being undervalued.

In addition, in step (d), when a current value of the spread graph is a point adjacent to any one peak point on the spread graph, a primary profit rate may be calculated based on the time point at which the current value is expected to regress to an average or a linear regression estimation value on the spread graph from the present, and a secondary profit rate may be calculated based on the time point at which the current value is expected to regress to a peak point of an opposite phase on the spread graph.

In addition, in step (d), recommendation for selling the overvalued financial product may include recommendation for short selling, selling contract of derivatives future trading, or margin trading of the financial product.

In addition, step (d) may include (d-1) dividing a section of two financial products with a predetermined split value for a predetermined period, inquiring the volatility of the spread graph for each day, which is recorded for each dividing time point, determining that a fluctuation rate of a current section reaches the highest numerical value that is capable of being reached in the current divided section when an absolute value of the fluctuation rate of the current spread exceeds the volatility in a state where the volatility is inquired, and recommending buying and selling of the financial product so that current buying and selling prices of the financial products realize the highest expected profit rate; and (d-2) recommending a financial product that realizes the expected profit rate when buying or selling the financial product in consideration of the volatility of the spread graph for any one financial product and the ratio of the standard deviation or standard error of the current price according to the adjustment of the expected profit rate by the minimum expected profit rate setting UI of the financial product recommendation UI.

According to an example of the present disclosure, there is provided a main server performing a method for recommending financial product sales strategy based on detection of financial products in similar trend, the main server including: a memory storing a program for performing the method; and a processor for executing the program, in which the method includes (a) inquiring price information of a plurality of financial products according to elapsed time; (b) extracting at least one financial product pair or more determined to have a same price trend or a price trend equal to or less than a predetermined difference on specific period information from among the plurality of financial products; (c) determining a periodicity of a spread graph for a price difference or price ratio of two financial products in the extracted financial product pair, and selecting a recommended financial product pair based on at least one of the average, standard deviation, trend line by regression analysis, and standard error of the spread graph; and (d) recommending at least one of borrowed selling, short selling, future selling contract, and net selling only limited to the user terminal that already owns the financial product for an overvalued financial product, recommending buying for an undervalued financial product among two recommended financial product pairs when a current value on the spread graph for the recommended financial product pair is equal to or greater than a predetermined standard deviation or a multiple of the standard error, and providing the user terminal with profit rate information about an expected profit rate for a predetermined period after the time point of selling or buying.

The present disclosure may suggest an arbitrage trading strategy for a financial product pair to a user by proposing the method for recommending financial product sales strategy based on detection of financial products in similar trend.

In addition, in the process of selecting the financial product pair, it is possible to configure a financial product pair that show a similar trend and similar volatility by discriminating trends including sideways, upward and downward trends, and it is possible to configure a financial product pair that may estimate the timing of buying/selling each asset by determining the difference between the two asset prices, that is, the seasonality of the spread.

In addition, it is possible to calculate a graph of the asset price difference (spread) through the asset price graph of each configured pair, and analyze the normal distribution of the calculated spread graph.

Furthermore, based on the normal distribution of the spread graph, by providing a trading strategy for the financial product pair in which a value deviating from a predetermined normal distribution by equal to or greater than a predetermined value is searched, regardless of the influence of the financial market, since an expected profit as much as the spread between the prices of respective financial products is achieved and pursued through arbitrage trading, it is possible to manage an investment portfolio that minimizes the influence of market risk.

Therefore, it is possible to provide the user with diversification of investment strategies capable of eliminating market risk by being able to take a short selling strategy for the financial product in addition to strategies for buying low and selling high for the financial product.

In other words, through statistical arbitrage trading techniques, even if one asset suffers a loss with limited resources, the overall investment portfolio records a net profit by recording a larger profit from the investment asset in the opposite position. Therefore, it is possible to provide an investment method capable of increasing profit more stably than a normal diversified investment technique that inevitably accompanies a decline in asset values in case of a market shock such as a financial crisis.

In addition, when trading is performed based on indicators such as oscillator indicators and RSI indicators in the normal financial product trading market, in a case where the stock price rises further even if a specific financial product reaches the overbought section, that is, in a case where the meaning of the indicators described above has faded as a basis in an uptrend or a downtrend, the present disclosure may generate profits only with the spread profit rate regardless of the situation of the financial product trading market.

In addition, in the present disclosure, in a case where a number of financial products having similar price properties are output to the user terminal at once and provided, it is possible to first select financial product pairs having similar price property tend for an overload on the user terminal or server, and provide the user terminal with only accurate and limited financial products through the periodicity and seasonality analysis process of the spread value. Therefore, it is possible to recommend accurate item pairs while using relatively less computing power than before.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a structural diagram of a system of a method for recommending financial product sales strategy based on detection of financial products in similar trend according to an example of the present disclosure;

FIG. 2 is a block diagram showing an internal configuration of a main server according to an example of the present disclosure;

FIG. 3A is an exemplary diagram of a price information graph of company A according to an example of the present disclosure;

FIG. 3B is an exemplary diagram of a price information graph of company B according to an example of the present disclosure;

FIG. 3C is an exemplary diagram of a price comparison graph, a price average line, and a recommendation point for sales according to an example of the present disclosure;

FIG. 4 is an exemplary diagram of a normal distribution table used for recommending a financial product according to an example of the present disclosure;

FIG. 5 is an exemplary diagram of a price comparison graph and a spread graph between price information of financial products within a financial product pair according to an example of the present disclosure;

FIG. 6 is an exemplary diagram of a financial product recommendation UI on a UI provided to a user terminal according to an example of the present disclosure; and

FIG. 7 is a flow chart for the execution sequence of a method for recommending financial product sales strategy based on detection of financial products in similar trend according to an example of the present disclosure.

### DETAILED DESCRIPTION

Hereinafter, examples of the present disclosure will be described in detail so that those skilled in the art may easily practice the present disclosure with reference to the accompanying drawings. However, the present disclosure may be embodied in many different forms and is not limited to the examples described herein. In addition, in order to clearly explain the present disclosure in the drawings, parts irrelevant to the description are omitted, and similar reference numerals are attached to similar parts throughout the specification.

Throughout the specification, when a part is said to be “connected” to another part, this includes not only the case where it is “directly connected” but also the case where it is “electrically connected” with another element interposed therebetween. In addition, when a certain component is said to “include”, this means that it may further include other components without excluding other components unless otherwise stated.

In this specification, a “unit” includes a unit realized by hardware, a unit realized by software, and a unit realized using both. Further, one unit may be realized using two or more hardware, and two or more units may be realized by one hardware. On the other hand, ‘˜ unit’ is not limited to software or hardware, and ‘˜ unit’ may be configured to be in an addressable storage medium or configured to reproduce one or more processors. Therefore, as an example, ‘˜unit’ refers to components such as software components, object-oriented software components, class components, and task components, processes, functions, properties, procedures, subroutines, segments of program code, drivers, firmware, microcode, circuitry, data, databases, data structures, tables, arrays, and variables. Functions provided within components and ‘˜units’ may be combined into smaller numbers of components and ‘˜units’ or further separated into additional components and ‘˜units’. In addition, components and ‘˜units’ may be implemented to play one or more CPUs in a device or a secure multimedia card.

A “user terminal” referred to below may be implemented as a computer or portable terminal capable of accessing a server or other terminals through a network. Here, the computer may include, for example, a notebook, desktop, laptop, VR HMD (for example, HTC VIVE, Oculus Rift, GearVR, DayDream, PSVR, etc.) equipped with a web browser, etc. Here, the VR HMD includes all of models for PC (for example, HTC VIVE, Oculus Rift, FOVE, Deepon, etc.), for mobile (for example, GearVR, DayDream, Stormtrooper, Google Cardboard, etc.), and for console (PSVR), and It includes all independently implemented Stand Alone models (for example, Deepon, PICO, etc.). A portable terminal is, for example, a wireless communication device that ensures portability and mobility, and may include not only smart phone, tablet PC, and wearable device, but also various devices equipped with communication modules such as Bluetooth (BLE), NFC, RFID, ultrasonic waves (Ultrasonic), infrared, Wi-Fi, and LiFi. In addition, “network” refers to a connection structure capable of exchanging information between nodes such as terminals and servers, and includes a local area network (LAN), a wide area network (WAN), and the Internet. (WWW: World Wide Web), wired and wireless data communications networks, telephone networks, wired and wireless television communications networks, etc. Examples of wireless data communication networks include 3G, 4G, 5G, 3rd Generation Partnership Project (3GPP), Long Term Evolution (LTE), World Interoperability for Microwave Access (WIMAX), Wi-Fi, Bluetooth communication, infrared communication, ultrasonic communication, visible light communication (VLC), LiFi, etc., but are not limited thereto.

The present disclosure relates to a method for recommending a selling and buying strategy to a user terminal 200 by detecting a financial product pair showing a similar trend and comparing and analyzing price information between the two financial products.

Through this, the present disclosure also relates to a technology in which when trading is performed based on indicators such as oscillator indicators and RSI indicators in the normal financial product trading market, in a case where the stock price rises further even if a specific financial product reaches the overbought section, that is, in a case where the meaning of the indicators described above has faded as a basis in an uptrend or a downtrend, the present disclosure may generate profits only with the spread profit rate regardless of the situation of the financial product trading market.

To this end, in the present disclosure, buying and selling of the financial product may be recommended, as means for generating profits, based on a spread graph of a plurality of financial products, when the spread graph reaches a specific point, or at the peak value of the spread graph.

Hereinafter, a method and a system for recommending financial product sales strategy in similar trend according to an example of the present disclosure will be described in detail.

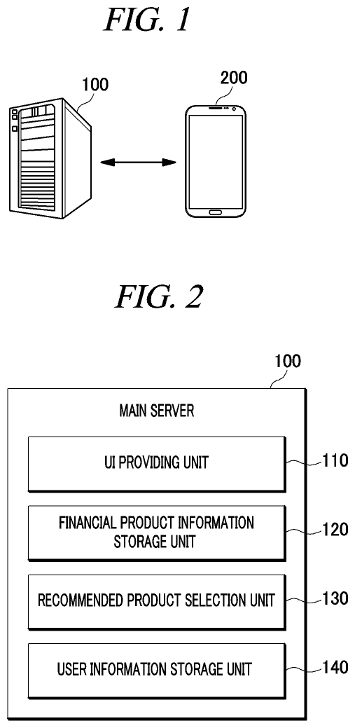

First, with reference to FIG. 1, a system for recommending financial product sales strategy based on detection of financial products in similar trend according to an example of the present disclosure will be described.

Referring to FIG. 1, the system for recommending financial product sales strategy based on detection of financial products in similar trend according to an example of the present disclosure may include a main server 100 and a user terminal 200.

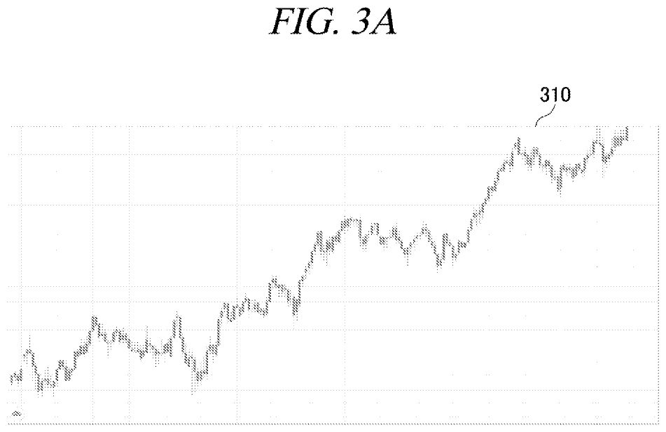

Referring to FIG. 2, the main server 100 may include a memory storing a program (or application) for performing the method for recommending financial product sales strategy based on detection of financial products in similar trend and a processor for executing the above program.

Here, the processor may perform various functions according to the execution of the program stored in the memory. Depending on each function, the detailed components included in the processor may be represented by a UI providing unit 110, a financial product information storage unit 120, and a recommended product selection unit 130, and a user information storage unit 140.

The UI providing unit 110 provides the user terminal 200 with a financial product recommendation UI including at least one of a period information input function, a desired profit rate input function, a price comparison graph display function, and a detailed information UI.

The user may set a financial product to be searched through the provided financial product recommendation UI, and may provide the main server 100 with the financial product by inputting period information and desired profit rate used to analyze the corresponding financial product.

The financial product information storage unit 120 may serve to store information about a plurality of financial products, collect information about at least one financial product by the main server 100 being connected to the Internet, and update the information It every predetermined cycle.

The recommended product selection unit 130 selects a financial product to be recommended to the user terminal 200 through a predetermined algorithm and price difference analysis. The detailed recommended financial product selection operation will be described in detail later.

The user information storage unit 140 may identify a plurality of user terminals 200 or users by storing personal information and identification information for the users, and store a history of financial products recommended to the identified user.

In addition, according to another example of the present disclosure, the main server 100 of the present disclosure may recommend a financial product excluding previously recommended financial products from future recommendations based on the previously recommended financial product history stored for each user identified through the user information storage unit 140.

When selecting a financial product pair, the present disclosure selects a financial product pair in which the price difference or ratio flow between the two financial products is sufficiently seasonal, periodic, or stationary, so the slope in the price spread flow is not considered, and simply mean values and standard deviations are used.

According to another example of the present disclosure, a regression analysis method or standard error may be used to select the financial product pair.

The user terminal 200 includes normal electronic equipment (smart phone, desktop, tablet PC, etc.) capable of communicating with the main server 100 by being connected to a communication network by wire or wireless, and may be provided with an application for recommending financial product sales strategy based on detection of financial products in similar trend, or may be accessed to a web page that performs the method for recommending financial product sales strategy based on detection of financial products in similar trend.

Hereinafter, the method for recommending financial product sales strategy based on detection of financial products in similar trend performed by the main server 100 according to an example of the present disclosure will be described.

First, the main server 100 provides the user terminal 200 with the financial product recommendation UI 210 including at least one of the period information input function, the desired profit rate input function, the price comparison graph 330 display function, the minimum expected profit rate setting UI, and the detailed information UI.

In this case, the price comparison graph 330 includes a price information graph of two financial products of the financial product pair, and may display the two price information graphs, and display and provide a price difference portion to be identified.

In addition, the main server 100 may receive an adjustment input for the minimum expected profit rate from the user terminal 200 through the minimum expected profit rate setting UI.

At this time, the minimum expected profit rate may include, in addition to the profit rate that the user desires to obtain by selling a plurality of financial products already owned, the profit desired to be obtained by selling a plurality of financial products that the user does not yet possess.

According to an additional example of the present disclosure, as the minimum expected profit rate is adjusted, a financial product may be selected as the recommended product by in consideration of the volatility of the spread graph, the current prices of a plurality of financial products, the standard deviation for a specific period, and a rate with standard error which will be described later.

Subsequently, the period information is received from the user terminal 200, and the price information of the plurality of financial products according to elapsed time is inquired based on the period information.

Thereafter, the main server 100 extracts at least one financial product pair or more determined to have the same or similar trend during a specific period from among the plurality of inquired financial products.

At this time, the similar trend according to an example of the present disclosure may be divided into a plurality of predetermined intervals for specific period information among a plurality of financial products, and in the above intervals, a pair of financial products whose price information rises or falls together or a financial product having the same trend line or a predetermined difference due to price fluctuations may be determined to have a similar trend. According to an additional example of the present disclosure, in a case where the ‘interval’ in which the price information increases or decreases simultaneously in the interval is equal to or more than a predetermined number of times, it may be determined that the price trend is less than or equal to a predetermined difference.

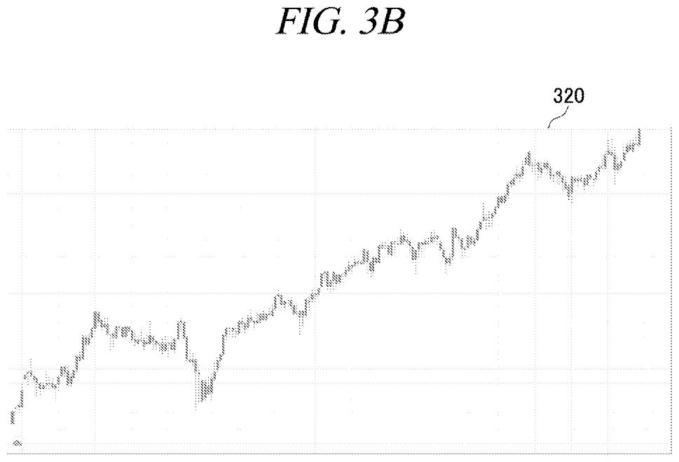

Referring to FIGS. 3A and 3B, for example, assuming that the graph shown in FIG. 3A is the price information graph 310 of company A and the graph shown in FIG. 3B is the price information graph 320 of company B, the main server 100 according to an example of the present disclosure may divide, at a plurality of predetermined intervals, period information received from the user terminal 200 among a plurality of financial products pre-stored in the financial product information storage unit 120, and extract, as financial products that are determined to have a trend, the financial products of Company A and Company B whose price information fluctuates in a similar trend in the intervals, or whose interval of rising or falling together is equal to or more than a predetermined number of times.

Referring to FIG. 3C, as in the above example, a price comparison graph 330 may be calculated by comparing the price information graphs of company A and company B, and the price comparison graph 330 may include a set period corresponding to the period information and a price average line (340, or trend line) of the financial product corresponding to the period information, and by calculating the spread graph 300 from the price comparison graph 330, a buying recommendation point 302 and a selling recommendation point 301 may be provided.

At this time, the main server 100 may calculate the spread graph 300 for a price difference ratio during a set period corresponding to the period information received from the user terminal 200.

The spread graph 300 may be generated based on various indicators, such as a price difference between two financial products or a value based on a price ratio. For example, it may be generated based on a calculated value of “Company A stock price—Company B stock price” or “Company A stock price/Company B stock price”. The spread graph 300 may be a graph in which a change in the price ratio between the two financial products is expressed as a line for a predetermined period.

According to another example of the present disclosure, the price of the spread graph 300 may include a line connecting between the full start or the full end points set based on the market price of calculated on daily, minute, or hourly basis (1 minute/5 minutes/1 hour/1 day/1 week, etc.) according to the time of each financial product.

In this example, the price line of the spread graph 300 actually creates timeslots in units of minute candle, hour candle, day candle, and week candle, like a mobile trading system (MTS) chart provided by a typical securities company application or program, and may be formed in a way that connects the spread price at each time point within the entire set period.

As an additional example, a price comparison graph may be defined based on observed values for each specific set section, such as prices at predetermined time intervals (for example, 5 minutes and 1 hour) as well as daily opening and closing prices. Whether to determine the price at a certain time point may be specified in various ways. In particular, it may be applied to financial products that provide 24-hour trading without the concept of closing prices, such as cryptocurrency and foreign exchange markets.

In addition, the main server 100 may determine whether the spread graph 300 has a clear periodicity (or seasonality), and select a financial product pair determined to have the clear periodicity. The clear periodicity means that the amplitude of the wave of the spread graph is large, the amplitude is uniform, or the period of the wave is uniform and periodic.

In addition, in the process of extracting the financial product pair determined to have a similar trend, the main server 100 may search for two financial products having a high price similarity among a plurality of financial products, and search for a plurality of financial products having a difference or ratio between the volatility of the prices of two financial products for a specific period within a predetermined range, among a plurality of financial products to extract the two financial products as a pair of financial instruments.

Therefore, in the present disclosure, since the volatility of the prices of a plurality of financial products is calculated and then the financial products in which the difference between respective volatilities is neither too small nor too large are extracted, it is possible to realize stable statistical arbitrage trading through the extracted financial products.

This is because, in an ideal example, when the spread graph shows a sin wave shape, the difference in volatility and common trend characteristics between the prices of two financial products configured of a financial product pair are clearly identified, so a financial product pair more suitable for statistical arbitrage trading is extracted. In the financial product pair configured in the preferred example, the slope of the spread time series at the time of extraction has a value close to 0, and since the periodicity is excellently detected in the process of determining the seasonality of the spread, the spread time series stands out as a form of moving horizontally.

On the other hand, according to additional example of the present disclosure, as another extraction method, by searching for financial products in which the slope of the spread graph for the price of two financial products during a specific period among a plurality of financial products is equal to or greater than, or less than a predetermined value, or within a predetermined range, the financial products are extracted as a financial product pair. Therefore, a financial product pair in which the spread time series of the prices of the two financial product has an upward momentum or a downward momentum may be extracted.

Through this, the present disclosure also may strategically utilize a financial product pair in which the spread has periodicity but moves upward or downward for a while. To find the financial product pair, the slope of the spread time series may be extracted and utilized under an extraction condition, such as a positive slope, a negative slope, or a slope within a certain range.

For example, assuming that financial products A, B, and C are extracted as product pairs, a case where the price of financial product A rises 1% and the price of financial product C rises 4% may be searched for as a more suitable financial product than a case where the price of financial product A rises 1% and the price of financial product B rises 2, and since the difference in volatility between financial product A and financial product C is clear, it may be extracted as the financial product pair.

According to an additional example of the present disclosure, a volatility adjustment function may be further included and displayed on the financial product recommendation UI, and in a case where the volatility value is adjusted by the user terminal 200, a financial product having a volatility difference corresponding thereto may be searched and extracted as the financial product pairs.

Subsequently, the main server 100 may calculate at least one of the average, standard deviation, trend line based on regression analysis, and standard error of the spread graph, and select a recommended financial product pair based on the calculated value.

At this time, when the slope of the wave by the line displayed on the spread graph is 0 or within a predetermined value range (for example, −0.1 or more and +0.1 or less), the average and standard deviation are calculated, and when the wave slope is out of a predetermined numerical range, the trend line and standard error may be calculated by y regression analysis technique.

In the case of this example, if the slope of the spread is distributed around 0, it is okay to use the average or standard deviation (because it is close to horizontal), but as the slope of the spread moves away from 0 in the positive or negative direction, the slope is sharp, so that the regression analysis is applied in this case.

Accordingly, the main server 100 may also calculate the trend line and standard error of the trend of the financial product or the financial product pair when the slope is negatively large.

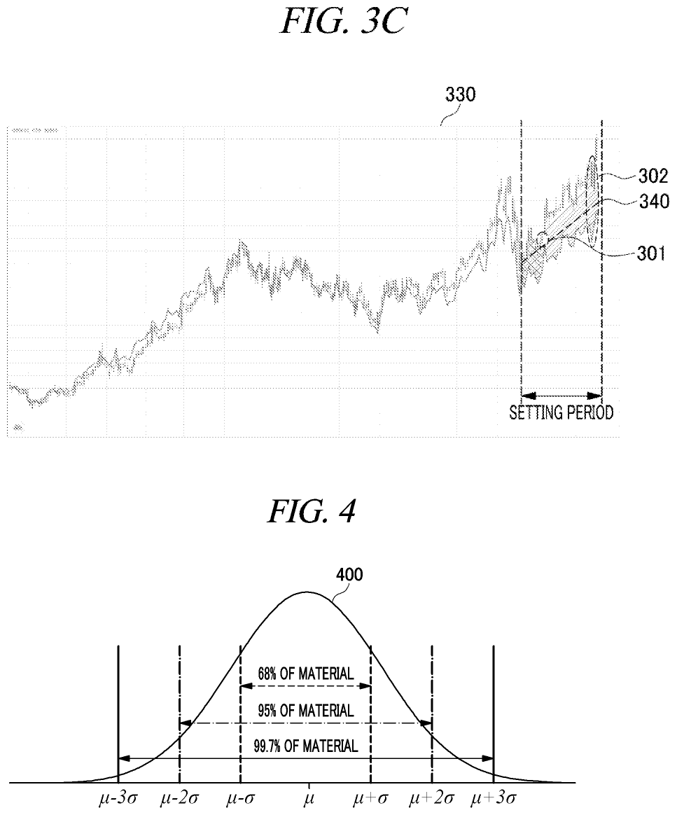

Referring to FIG. 4, the main server 100 may calculate the standard deviation or standard error for the spread graph 300, and determine whether to recommend the financial product pair depending on how many multiples of the standard deviation or standard error the current value is.

In the price difference normal distribution table 400, the median value (average value) is set as μ, and the standard deviation is designated as σ.

At this time, the standard deviation is a representative numerical value indicating how spread out data of a statistical group is centered on the average.

That is, as the multiple of the standard deviation corresponding to the current value is closer to 0 (for example, 0.5σ and 1σ), it means that the current value is concentrated around the average value μ, and as the standard deviation corresponding to the current value is farther from 0 (for example, 2σ and 3σ), it means that the current value is far from the average value.

In general, as shown, about 95% of standard normal distribution data is distributed within 2σ about the average. That is, if the current value corresponds to 3σ, it means that it is significantly out of the average, and in other words, it may be said that the possibility of regressing to the average is very high.

In a case where the price comparison graph 330 of financial products is analyzed based on the price difference normal distribution table 400 by substituting this in the case of price information of the financial products, if the current value is a value corresponding to −3σ, the current value is located at a significant low point in the stock price graph, which may mean that it is highly likely to rise soon.

Conversely, if the current value is a value corresponding to +3σ, the current value is located at a significant high point in the stock price graph, which may mean that it is highly likely to fall soon. If the current value corresponds to 1σ, the probability of falling and the probability of rising are similar, so it is preferable to make a recommendation to the user when the current value corresponds to ±3σ. Meanwhile, the multiple of ±3 is only an example, and different multiples may be applied according to various examples.

The principle of this normal distribution table may be equally/similarly applied to the concept of the regression analysis and standard error. That is, if the current value is a value that corresponds to ±3 multiples of the standard error, it means that there is a very high possibility of regressing to the average trend line or price average line, and at this point, buying/selling may be recommended.

Therefore, in a case where this principle is applied to the spread graph 300, there is a high possibility of achieving higher profit rate in a case where the buying/selling of a specific item is recommended at the timing corresponding to ±3σ rather than when the current value of the spread graph 300 corresponds to ±1σ.

Thereafter, when the current value on the spread graph for the selected financial product pair is equal to or greater than a predetermined standard deviation or a multiple of the standard error (for example, the spread graph indicates that the current value is ±3σ or ±4σ), the main server 100 may recommend selling for the highly evaluated financial product among two recommended financial product pairs, recommend buying for the undervalued financial product, and provide the user terminal with profit rate information about the expected profit for a predetermined period after the time point of selling or buying.

At this time, the main server 100 may extract only financial product pairs whose current values are ±3σ and ±4σ among all financial product pairs which are selected to have high periodicity. That is, only financial product pair whose current value is located at a peak point or a point adjacent to the peak point on the spread graph may be extracted.

In addition, the main server 100 calculates the average and standard deviation of the price of each financial product for the two financial products of the recommended financial product pair, and calculates the normalized price through the current value and standard deviation of each financial product.

The normalized price according to an example of the present disclosure may be calculated in various ways, but in a representative example, it may be calculated through a formula such as ((current price of financial product−average price)/standard deviation)).

Based on the normalized price calculated as described above, the main server 100 may determine that any one financial product pair or a financial product, of which the normalized price is higher among a plurality of financial products or equal to or greater than a predetermined value, is overvalued, and the rest of the financial products is undervalued.

However, in this example, when calculating the spread between financial products or between financial product pairs, overvaluation and undervaluation are executed with a moved for evaluating A overvaluation (numerator) and B undervaluation (denominator) when the current value of the spread is above the spread average of the ratio (A/B), and A undervaluation (numerator) and B overvaluation (denominator) when the current value of the spread is below the spread average of the ratio (A/B) by using the ratio between at least two financial products (assuming that financial product A and financial product B are calculated). However, in the present disclosure, since the method for determining the overvaluation and undervaluation and the method for measuring the spread may be implemented in various ways (for example, price difference, log spread, ratio spread, and the like), each method is not limited to the method in the above-described example.

Alternatively, as an additional example, a financial product whose current value is farthest from the average or trend line of the price graph of the corresponding financial product may be determined to be overvalued, and the remaining financial products may be determined to be undervalued.

In addition, selling may be recommended for the overvalued financial product, and buying may be recommended for undervalued financial products. Selling at this time may mean short selling. In other words, since the overvalued financial product is are highly likely to fall, selling is recommended based on a strategy of taking profits by short selling at that time, and then buying after falling. In addition, recommendation to sell overvalued financial product may be distinguished from recommendation to buy undervalued financial product by including contract of derivatives future trading or recommendation for margin trading of the financial product.

In addition, the recommendation for financial products performed by the main server 100 may include at least one of borrowed selling, short selling, future selling contract, and net selling only limited to the user terminal that already owns the financial product, in addition to simple selling and buying.

Then, the profit rate for each financial product may be calculated. Specifically, when the current value is a point adjacent to any one peak point on the spread graph, the primary profit rate may be calculated based on the time point at which it is expected to regress to the average on the spread graph from the present, and the expected price at the time, and the secondary profit rate may be calculated based on the time point at which it is expected to regress to the peak point of the opposite phase on the spread graph, and the expected price at that time.

In addition, the profit rate information according to an example of the present disclosure may be obtained by predicting the time point at which the spread graph is expected to regress to the average value from the current time point, and being calculated based on the ratio of the numerical value of the spread graph between the described-above time point and the current time point, and may be provided by calculating the expected profit rate for each selling point and buying point based on the end date or current time of the period information. In an another example, the profit rate information may be provided including the profit rate generated through arbitrage trading by reversing sales of each of buying and selling positions.

Furthermore, the profit rate information may be calculated and provided for each of a plurality of selling and buying points, through which the user may be provided with not only the profit rate when selling and buying are processed in the same day according to the sale method for the financial product pair according to the present disclosure, but also the profit rate when selling and buying are processed a few days or hours ago.

For example, in a case where the current value of the spread graph for the price of any one financial product is 4 and the average value of the spread graph is 3, the expected profit rate is ABS[(4−3)/3] or ABS[(4/3−1)] and may be calculated as 33%. As another example, in a case where the current value of the spread is 2 and the average value of the spread graph is 3, the expected profit rate is ABS[(2−3)/3] or ABS[(2/3−1)] and may be calculated as 33%.

At this time, since the result values of the method for obtaining the sum of the profit rate through comparison between respective financial products, and the method for comparing the current value and average value in the spread graph as described above are similar to each other, the main server 100 according to one example of the present disclosure may calculate the profit rate based on the spread graph.

Here, ABS (ABSloute) means a function that obtains an absolute value.

Through this, the present disclosure may achieve an expected profit equal to the spread between the prices of respective financial products through arbitrage trading regardless of the influence of the financial market, and since the expected profit is pursued, it is a technology capable of managing an investment portfolio that minimizes the influence of the financial market risk.

At this time, according to another example of the present disclosure, the main server 100 calculates the volatility of the daily spread graph for a predetermined period for any one financial product, and determines that the volatility of the prices of two financial products reaches at statistically highest timing in a case where the fluctuating rate per unit time, such as the minute and hour of the spread between the two assets at the current time.

In a case where the volatility determined as described above is inquired within the predetermined range, but the current price exceeds the volatility, by recommending to buy and sell the financial products at the timing when the selling amount and loss amount or the volatility is highest based on the current standard for the financial products, so that the investor may present the most favorable recommended buying and selling execution price for the two financial products at the time of the trading, in which the buying item is bought at a lower price and the selling item is sold at a higher price.

According to another example of the present disclosure, the main server 100 may inquire and provide the volatility of the spread graph for a predetermined period (for example, 1 month/3 months/6 months, and 1 year) for any one financial product.

Here, the volatility calculation may be performed by dividing the predetermined period into predetermined time slots (for example, 1 minute/1 hour/5 hours/day/week, etc.), and using the standard deviation for the continuous fluctuation rate of all past spread values corresponding to each divided time period.

Therefore, since it may be a practical guide when the sales are performed, the historical volatility value of the spread time series is provided together with the fluctuation rate of the current spread. In this state, in a case where the absolute value of the fluctuation rate of the current spread (1 minute/1 hour/5 hours/day/week, etc.) exceeds the inquired historical volatility, it is determined that the fluctuation rate of the current spread reaches the highest numerical value that may be reached in the period. Therefore, it may also recommend buying and selling the financial product at the most favorable timing for the financial product (execution price of each product having probabilistically highest expected profit rate).

Here, the historical volatility assumes that the standard deviation of the past values of the spread during the total observation period of the daily, minute, or hourly fluctuation rate is first obtained, and the future volatility of the spread is similar to this.

On the other hand, according to an another example of the present disclosure, in a case where the user has already completed the buying/selling execution, as the above manner, the main server 100 may make a prediction for the loss amount based on the multiple of the calculated section volatility of the spread, and suggest position clearing (losscut) point based on this.

At this time, in a case where the minimum expected profit rate is adjusted by the minimum expected profit rate setting UI of the financial product recommendation UI, in consideration of the volatility of the spread graph for any one financial product and the ratio of the standard deviation or standard error of the current price, it is possible to recommend a financial product that realizes the expected profit rate when buying or selling the financial product at the current time or designated time point.

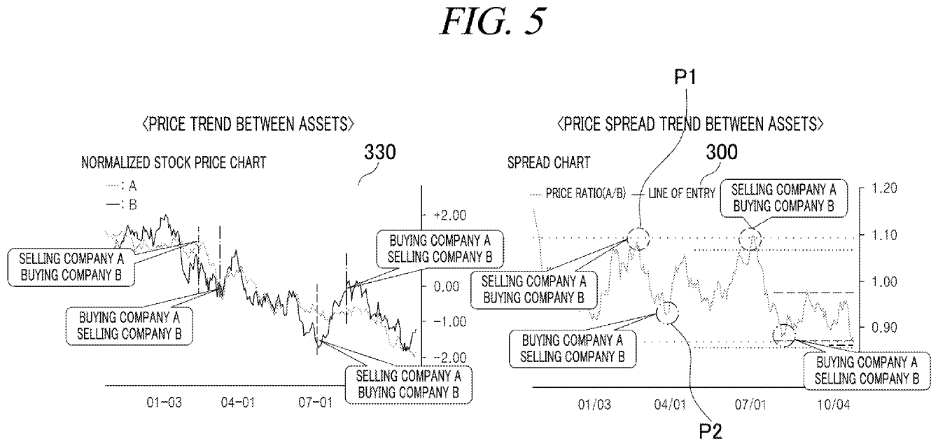

Hereinafter, with reference to FIG. 5, a spread graph and a method for recommending the selling/buying according to an example of the present disclosure will be described as an example.

The graph on the left is a price comparison graph, and the graph on the right of FIG. 5 is a spread graph. Similarly, it is assumed that Company A's stock price and Company B's stock price are determined to show similar trends and thereby they match as a financial product pair.

Looking at the graph on the right, the spread graph 300 draws a specific wave. It is a spread graph calculated based on the ratio or difference between the stock price of the Company A and the stock price of the Company B on the price difference graph, and the ratio or difference also draws a specific wave. In addition, it may be seen that the wave exhibits a specific periodicity.

Here, when the point corresponding to an upper peak point P1 (point around 9/14) arrives among the waves of the spread graph 300, a strategy of selling the product of company A and buying the product of company B may be recommended. At this time, the prices of the two financial products are is the most diverged. Thereafter, at a point corresponding to the next lower peak point P2 on the wave of the spread graph 300, a strategy of buying the product of company A and selling the product of company B may be recommended. At this time, the prices of the two financial products are at their most narrowed.

Here, when a selling/buying recommendation is made at the upper peak point P1, the profit rate may be calculated by selecting the average point between the upper peak point P1 and the lower peak point P2 on the spread graph as the first profit rate point, and calculated based on the prices of the financial products of company A and company B expected at the lower peak point P2 by selecting the lower peak point P2 as the secondary profit rate point.

Financial products that show such a similar trend may include stocks that are related to common stocks and preferred stocks, or stocks that are related to holding companies and affiliates, but various other financial products may show similar trend.

Therefore, the main server 100 according to an example of the present disclosure may help earn stable profits by investing in a financial product pair with limited resources with respect to a single financial product pair.

In other words, in a case of investing in a financial product pair, the present disclosure recommends selling when each financial product is overvalued at a specific point and recommends buying when each financial product is undervalued, so that even in a case where the two financial products are fall, one financial product may generate profits through short selling. Therefore, losses may be minimized, and also in a case where the two financial products rise, one financial product may generate profits through buying low and selling high, thereby generating profits beyond losses.

Depending on the user's investment propensity, the expected profit rates may differ from each other, but it is a common investment method to generate profits by selling overvalued financial product at the peak, and buying undervalued financial product at the low point and selling undervalued financial product at the peak. The present disclosure may provide an investment method that does not fail by setting an overvalued financial product and an undervalued financial product as one financial product pair at a specific time point.

Therefore, after entering a position (long/short) strategy for a specific financial product or financial product pair at a user's desired time, the user may predict how much profit may be made from the position when liquidating the financial product in the future.

In addition, since the present disclosure may recommend a financial product pair with a desired profit rate or higher when a specific desired profit rate is input, a larger number of financial product pairs may be searched if a lower desired profit rate is input.

Therefore, for each user's different expected profit rate, as the expected profit rate is lowered, pairs with lower expected profit rate are also recommended, resulting in more pairs being extracted.

In this regard, in order to find a financial product pair that match the desired profit rate entered by the user, the main server 100 infers the profits from the financial product price difference (current), the past average value of the financial product price differences (spread), the liquidation equilibrium point, and differences or distances from the regression point.

In addition, the main server 100 may provide a plurality of selling points for each buying and selling point, that is, the primary selling point and buying point, and an expected profit rate at the time point, provide the secondary selling point after the primary selling point and buying point, and provide an expected profit rate at the time point.

The selling point and the buying point may include a point at which at least one of the two financial products may generate a profit when the initially overvalued financial product is regressed to the average value or the undervalued financial product is regressed to the average value.

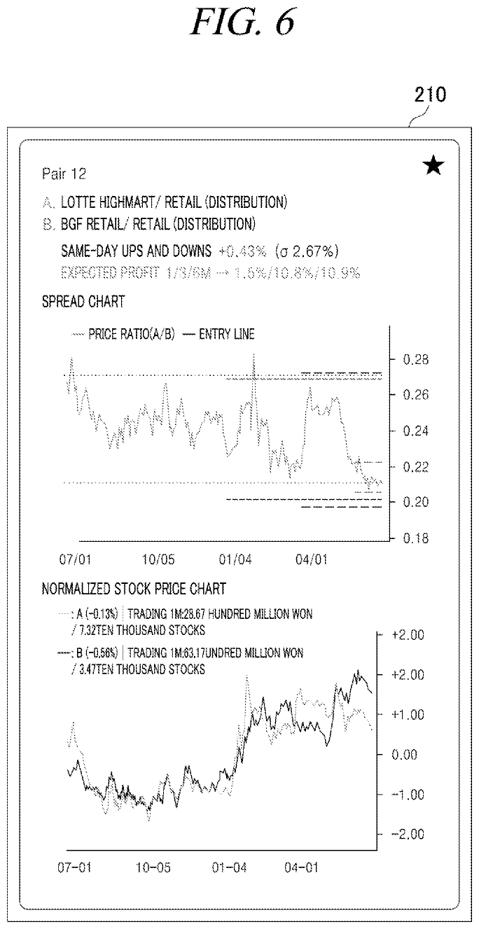

Referring to FIG. 6, financial products recommended by the main server 100 may be displayed on the user terminal 200 through the financial product recommendation UI as shown.

The lower graph of two graphs shown in FIG. 6 is a normalized price of each financial product, and unless such normalization is performed, a relative shape is not noticeable when comparing a plurality of graphs. To this end, as shown, the value of the Y-axis of the graph is determined based on 0.

In this case, the financial product recommendation UI may be implemented in various examples, and in a preferred example, may be implemented in a form in which at least one recommended financial product and the financial product pair are displayed on the user terminal 200, and the domestic or overseas market name of the financial product, the current buying or selling price, the name of the financial product, expected profit, and the price comparison graph 330 of the financial product pair are provided together.

In addition, according to an additional example of the present disclosure, in a case where the identifier is displayed on one side of the top of the financial product recommendation UI 210 and a click input is received from the user terminal 200, the currently displayed financial product pair may be stored as an interest pair.

In addition, with respect to a predetermined interest pair, when clicking again, the identifier may be released from the interest pair.

At the lower end of the identifier, information about the item name, industry classification, real-time spread fluctuation, volatility, and estimated expected profit rate for each spread analysis period with respect to the recommended financial product and recommended financial product pair may be displayed in text as shown, and each text may be configured of texts of different colors for easy identification.

Here, as shown in FIG. 5, the spread also includes the price comparison graph according to an example of the present disclosure, and may be a graph about the price ratio related to price fluctuations between financial products and financial product pairs during the period input from the user terminal 200.

The financial product recommendation UI according to an example of the present disclosure may also provide a stock price chart for each item of the financial product pair including real-time fluctuation rate and liquidity information for each item of the financial product pair, along with the spread graph 300 and the chart which are described above.

In addition, in a case where any one of the recommended financial products displayed on the user terminal 200 is selected and input, the main server 100 may additionally display and provide on the user terminal 200 with the information about the buying price and the loss price of the financial product, and expected profit for a plurality of recommended selling points, including information previously provided, through the detailed information UI. The profit rate setting UI may be provided together with the detailed information UI.

As an additional example, a standard deviation setting UI may be included. This is a UI for setting whether to receive a recommendation for a financial product pair corresponding to ±3σ of the current value on the spread graph.

Specifically, the main server 100 receives, from the user terminal, an input signal for inputting a parameter for setting the multiple of the standard deviation or standard error on the spread graph at the time of buying and selling between two financial products.

Thereafter, the average value, standard deviation, linear regression estimation value, and standard error of the spread graph between the two received financial products may be calculated, and the standard deviation or standard error according to the input signal may be provided as a financial product pair corresponding to a predetermined specific multiple.

Through this, the main server 100 according to an example of the present disclosure may use the average deviation and standard deviation of the spread graph in a manner of preliminarily detecting a spread that has already moved horizontally through seasonality verification.

In addition, according to an additional example, the profit rate setting UI may be provided by being displayed on one side of the top of the detailed information UI, and may include a reference date setting function capable of determining the start date of financial product pair search. The profit rate setting UI may arrange and show the expected profits in the descending order by obtaining expected profits of each financial product pair, show only pairs that are equal to or greater than the minimum expected profit, show only pairs that are equal to or less than the maximum expected profit, arrange and show the deviation level in the descending order based on the average/standard deviation of the spread price, or select and show only pairs having a spread position value located in a previously input standard deviation section.

According to another example of the present disclosure, the reference date setting function sets a period from the set reference date to the implementation date of the present disclosure in a case where a separate input is not received from the user terminal 200, but may set the end date from the start date of the period by receiving a separate date from the user terminal 200.

In addition, according to an additional example of the present disclosure, the profit rate setting UI may provide pair view style, pair universe setting, pair extraction and sorting, and pair spread periodicity filter setting functions in addition to the reference date setting, and arbitrarily change a viewing mode displayed on the user terminal 200 to a separate viewing style such as chart type and text type.

According to an example of the present disclosure, a specific financial product or a specific financial product pair enables setting standards for international stock market classification (for example, KOSDAQ, NASDAQ, etc.) to which the corresponding financial product and financial product pair belong. Therefore, the financial products and financial product pairs belonging to international stock market classifications may be searched, and the financial products may include various financial assets including funds, foreign exchange, and cryptocurrencies in addition to stocks.

In addition, according to an additional example of the present disclosure, the pair extraction and sorting function and the pair spread periodicity filter may support a plurality of viewing modes by allowing the user to arbitrarily set a minimum expected profit, an observation period spread deviation range, and a sorting criterion.

In the case of the minimum expected profit and spread deviation range, how far away from the average value the standard deviation and standard error of the price during the set period for the price of the financial product and financial product pair currently displayed on the user terminal are to be searched. Therefore, the larger the minimum expected profit and spread deviation range are set, the more financial product pairs and financial products that are far from the average value may be searched and recommended.

That is, the main server 100 selects, as a financial product pair, financial products corresponding to a state where the current value of the spread graph is separated from the average value or the central value of the trend line among a plurality of financial products.

In addition, the pair spread periodicity filter may also receive settings for periodicity level, spread trend intensity, inter-stock correlation, and inter-stock volatility ratio, and based on this, it may be set to recommend by searching for values further away from the standard deviation and standard error.

Here, when the waveform of the spread graph is periodically repeated, the trend intensity according to an example of the present disclosure may increase in proportion to the number and period of repetitions of the cycle.

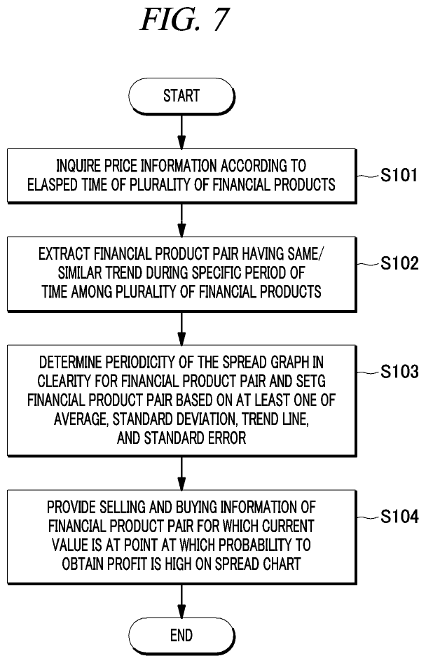

Hereinafter, referring to FIG. 7, the execution sequence of the method for recommending financial product sales strategy based on detection of financial products in similar trend according to an example of the present disclosure will be described.

First, the main server 100 inquires price information according to elapsed time of a plurality of financial products (S101).

Next, at least one financial product pair or more determined to have a same price trend or a price trend equal to or less than a predetermined difference during a specific period among a plurality of financial products is extracted (S102).

Thereafter, the periodicity of the spread graph for the price difference or price ratio of the two financial products in the extracted financial product pairs is determined, and a recommended financial product pair is selected based on at least one of the average, standard deviation, trend line by regression analysis, and standard error of the spread graph (S103).

The main server 100 recommends the user terminal 200 to sell the overvalued financial products and buy the undervalued financial products among two recommended financial product pairs when the current value on the spread graph for the recommended financial product pair is equal to or greater than a predetermined standard deviation or a multiple of the standard error. At this time, the profit rate information about the expected profit for a predetermined period after the time point of selling or buying is provided (S104).

An example of the present disclosure may be implemented in the form of a recording medium including instructions executable by a computer, such as program modules executed by a computer. Computer readable media may be any available media that may be accessed by a computer and includes both volatile and nonvolatile media, removable and non-removable media. In addition, computer readable media may include all computer storage media. Computer storage media includes both volatile and nonvolatile, removable and non-removable media implemented in any method or technology for storage of information such as computer readable instructions, data structures, program modules or other data.

Although the method and system of the present disclosure have been described with reference to specific examples, some or all of their components or operations may be implemented using a computer system having a general-purpose hardware architecture.

The above description of the present disclosure is for illustrative purposes, and those skilled in the art may understand that it may be easily modified into other specific forms without changing the technical spirit or essential features of the present disclosure. Therefore, the examples described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the detailed description above, and all changes or modifications derived from the meaning and scope of the claims and equivalent concepts should be interpreted as being included in the scope of the present disclosure.

What is claimed is:

1. A method for recommending financial product sales strategy based on detection of financial products in similar trend, the method comprising:
(a) inquiring price information of a plurality of financial products according to elapsed time;
(b) extracting at least one financial product pair or more determined to have a same price trend or a price trend equal to or less than a predetermined difference on specific period information from among the plurality of financial products;
(c) determining a periodicity of a spread graph for a price difference or price ratio of two financial products in the extracted financial product pair, and selecting a recommended financial product pair based on at least one of an average, standard deviation, trend line by regression analysis, and standard error of the spread graph; and
(d) recommending at least one of borrowed selling, short selling, future selling contract, and net selling only limited to a user terminal that already owns the financial product for an overvalued financial product, recommending buying for an undervalued financial product among two recommended financial product pairs when a current value on the spread graph for the recommended financial product pair is equal to or greater than a predetermined standard deviation or a multiple of the standard error, and providing the user terminal with profit rate information about an expected profit rate for a predetermined period after the time point of selling or buying.

2. The method for recommending financial product sales strategy based on detection of financial products in similar trend of claim 1, wherein the spread graph is a graph in which an amount of a change in a value divided between prices of two financial products or a difference value therebetween is expressed as a line for a predetermined period.

3. The method for recommending financial product sales strategy based on detection of financial products in similar trend of claim 1, wherein the profit rate information predicts a point at which the spread graph is expected to regress to an average value from a current time point, and is calculated based on a ratio of a numerical value of the spread graph between the time point and the current time point.

4. The method for recommending financial product sales strategy based on detection of financial products in similar trend of claim 1, wherein in step (a),
the user terminal is provided with a financial product recommendation UI including at least one of a period information input function, a desired profit rate input function, a price information graph display function, a minimum expected profit rate setting UI, and a detailed information UI, and the period information is received from the user terminal.

5. The method for recommending financial product sales strategy based on detection of financial products in similar trend of claim 4, wherein the financial product recommendation UI further includes a volatility adjustment UI that receives a volatility value from the user terminal and adjusts a range of the volatility between items for searching for a financial product pair whose volatility ratio for price changes of two items is within a certain input range.

6. The method for recommending financial product sales strategy based on detection of financial products in similar trend of claim 4, wherein the financial product recommendation UI further includes a standard deviation and standard deviation setting UI that receives, from the user terminal, an input signal for inputting a parameter for setting a multiple of the standard deviation or standard error on the spread graph at the time of buying and selling between two financial products, calculates the average, standard deviation, linear regression estimation value, and standard error of the spread graph between specific two financial products, and provides a financial product pair for which the current value of the spread graph corresponds to a predetermined multiple of the standard deviation or the standard error according to the input signal.

7. The method for recommending financial product sales strategy based on detection of financial products in similar trend of claim 1, wherein step (b) includes
dividing, at a plurality of predetermined intervals, the period information for specific period information among the plurality of financial products, and determining to have a similar trend when price information rises or falls together at the interval, or a slope of a trend line of each financial product derived by regression analysis is within a predetermined difference.

8. The method for recommending financial product sales strategy based on detection of financial products in similar trend of claim 1, wherein in step (b),
two financial products with high price similarity of a plurality of financial products are searched, and
step (b) includes (b-1) searching for two financial products whose price volatility difference or ratio between the two financial products for a specific period information is equal to or greater than, or less than a predetermined numerical range among a plurality of financial products, and extracting the two financial products as a financial product pair.

9. The method for recommending financial product sales strategy based on detection of financial products in similar trend of claim 1, wherein in step (b),
two financial products, whose desired profit rate corresponds to the expected profit value when the expected profit value is equal to or greater than the desired profit rate input in the user terminal by being compared, based on the expected profit value when liquidating a position estimated from a distance between a current value of the spread graph between two financial products, and each average value of a measurement period of the spread graph between the two financial products, when the desired profit rate received from the user terminal is equal to or greater than a predetermined value among the plurality of financial products, are extracted as the financial product pair.

10. The method for recommending financial product sales strategy based on detection of financial products in similar trend of claim 1, wherein in step (c),
an average and standard deviation method is applied when the spread graph has no slope or has a slope equal to or less than a predetermined value, and a regression analysis and standard error method is applied when the slope of the spread graph is equal to or greater than, or less than the predetermined value.

11. The method for recommending financial product sales strategy based on detection of financial products in similar trend of claim 1, wherein in step (d),
an average and a standard deviation of a price of each financial product is calculated for the two financial products of the recommended financial product pair, a financial product, of which a normalized price obtained by normalizing a current value of each financial product is higher in the two financial product, is determined as being overvalued, and the rest thereof is determined as being undervalued.

12. The method for recommending financial product sales strategy based on detection of financial products in similar trend of claim 1, wherein in step (d),
when a current value of the spread graph is a point adjacent to any one peak point on the spread graph,
a primary profit rate is calculated based on the time point at which the current value is expected to regress to an average or a linear regression estimation value on the spread graph from the present, and a secondary profit rate is calculated based on the time point at which the current value is expected to regress to a peak point of an opposite phase on the spread graph.

13. The method for recommending financial product sales strategy based on detection of financial products in similar trend of claim 1, wherein in step (d),
recommendation for selling the overvalued financial product includes recommendation for short selling, selling contract of derivatives future trading, or margin trading of the financial product.

14. The method for recommending financial product sales strategy based on detection of financial products in similar trend of claim 1, wherein step (d) includes
(d-1) dividing a section of two financial products with a predetermined split value for a predetermined period, inquiring a volatility of the spread graph for each day, which is recorded for each dividing time point, determining that a fluctuation rate of a current section reaches the highest numerical value that is capable of being reached in the current divided section when an absolute value of the fluctuation rate of the current spread exceeds the volatility in a state where the volatility is inquired, and recommending buying and selling of the financial product so that current buying and selling prices of the financial products realize the highest expected profit rate; and
(d-2) recommending a financial product that realizes the expected profit rate when buying or selling the financial product in consideration of the volatility of the spread graph for any one financial product and the ratio of the standard deviation or standard error of the current price according to an adjustment of the expected profit rate by the minimum expected profit rate setting UI of the financial product recommendation UI.

15. A main server performing a method for recommending financial product sales strategy based on detection of financial products in similar trend, the main server comprising:
a memory storing a program for performing the method; and
a processor for executing the program,
wherein the method includes:
(a) inquiring price information of a plurality of financial products according to elapsed time;
(b) extracting at least one financial product pair or more determined to have a same price trend or a price trend equal to or less than a predetermined difference on specific period information from among the plurality of financial products;
(c) determining a periodicity of a spread graph for a price difference or price ratio of two financial products in the extracted financial product pair, and selecting a recommended financial product pair based on at least one of an average, standard deviation, trend line by regression analysis, and standard error of the spread graph; and
(d) recommending at least one of borrowed selling, short selling, future selling contract, and net selling only limited to a user terminal that already owns the financial product for an overvalued financial product, recommending buying for an undervalued financial product among two recommended financial product pairs when a current value on the spread graph for the recommended financial product pair is equal to or greater than a predetermined standard deviation or a multiple of the standard error, and providing the user terminal with profit rate information about an expected profit rate for a predetermined period after the time point of selling or buying.
